(19) United States
(12) Patent Application Publication
(10) Pub. No.: US 2023/0238787 A1
(43) Pub. Date: Jul. 27, 2023

(54) Airtight Wall Connection Box

(71) Applicant: Dan Lehrmann, Kiryat Malachi (IL)

(72) Inventor: Dan Lehrmann, Kiryat Malachi (IL)

(21) Appl. No.: 17/844,190

(22) Filed: Jun. 20, 2022

Related U.S. Application Data
(60) Provisional application No. 63/302,077, filed on Jan. 23, 2022.

(51) Int. Cl. H02G 3/08

(52) U.S. Cl. CPC H02G 3/081; H02G 3/088

(57) ABSTRACT

There is generally provided a wall connection box (WCB), configured to be mounted over a suitable opening in the inner face of a wall of an insulated room, for conducting a utility (such as electric currents or fluids) between the space inside the room and any space outside it, the WCB including a base plate and one or more viaducts, embedded in, and across, the base plate in an airtight manner. Each viaduct is configured to conduct a particular type of utility—whether an electric current, electric or optical signal, a liquid or a gas. The base plate has a flange defined proximate its entire periphery and, attached or attachable to the flange, is a sealing gasket. The flange and the gasket are configured so that when the base plate is mounted on the wall, covering the opening and held pressed against it by suitable fasteners, there is an airtight joint between them.

This application draws priority from U.S. Provisional Application No. 63/302,077, filed Jan. 23, 2022.

### FIELD OF THE INVENTION

The invention generally addresses wall connection boxes, for conduction of electric currents and fluids across the wall, and particularly wall connection boxes that are airtight, for use in insulated rooms.

### BACKGROUND

In various facilities there exists an insulated room (sometimes also known as clean room), namely a closed room whose inside air is isolated from that of adjacent rooms and the atmosphere so that any exchange of air between them is only through special filters or other processing means. Examples of an insulated room include—
an operating theatre in a hospital, where the air must be sterile;
a so-called clean room in a semi-conductor wafer fabrication plant, where the air must be clean of dust and other particles;
various medical and biological laboratories, where the air must be sterile and/or clean of dust and other particles or where the air is contaminated and must be prevented from leaking to the surrounding;
enclosures with fire suppression systems, such as network servers or power turbines.

In some cases the insulted space may be more than a room—e.g. a section of a building or an entire building; the present invention is applicable to such a space as well and thus it should be understood to be included in the term “room”.

Typically, in an insulated room there are disposed various instruments that need connections with spaces outside the room, to supply to the instruments, for example, electric power or certain fluids (liquids or gases) or to exhaust certain fluids or to electrically communicate with outside instruments. There may also be a need to manually communicate with the outside by means of wall-mounted switches and indicators.

All such connections and means of communication must transcend a wall of the room. The term “wall” should be understood to include also ceiling and floor of the room. It is a common practice to construct them as part of connection boxes that are mountable within suitable openings in the wall. The problem is that the construction must be airtight. Various such constructions are known in prior art, but all of them are relatively complex, rendering them relatively expensive to fabricate and/or install and making them prone to failure, due to wear and/or mishandling.

### SUMMARY OF THE INVENTION

According to an aspect of the invention there is provided an improved wall connection box (WCB), configured to be mounted over, and/or inside, a suitable opening in the inner face of a wall of an insulated room, so as to enable conduction of an electric current or a fluid between the space of the insulated room and any space in or behind the wall, while forming an airtight seal between them.

The WCB of the invention primarily includes a solid base plate, formed along its entire periphery as a flat flange, to the back of which is attached a sealing gasket, configured so that when attached or joined to the inner face of the wall it forms an airtight seal over the wall opening. Embedded in the plate and joined thereto in an airtight manner are one or more viaducts, protruding from both faces of the plate. In various configurations of the invention, each viaduct is formed and configured to conduct either an electric current (as power) or a plurality of electric currents (as signal) or a fluid (gas or liquid—into, or out of, the room). The end of the viaduct protruding into the room is formed and configured for reversibly attaching thereto a suitable connector, preferably a standard connector, such as present at an end of a suitable cable or tube. The end of the viaduct protruding into the wall is formed and configured for semi-permanently attaching thereto a suitable wire, cable or tube.

According to another aspect of the invention there is provided an improved panel of multiple wall connection boxes, configured to be mounted over a suitable opening in the inner face of a wall of an insulated room, so as to enable conduction of electric currents and/or fluids between the space of the insulated room and any space in or behind the wall, while forming an airtight seal between them.

More specifically, the invention, in its first aspect, is of an airtight wall connection box (WCB), for mounting over an opening in a wall of an insulated room having an inner space or over an opening in a panel mounted in said wall, and for conducting a utility between said inner space and any space outside the insulated room, the wall connection box comprising—
a solid base plate, larger than said opening, having two faces and formed with a flat flange along its entire periphery;
one or more viaducts, each embedded in the base plate in an airtight manner so as to protrude from each of the faces and configured to conduct all or part of said utility; wherein the wall connection box is configured so that, when mounted on said wall or said panel over said opening and properly fastened, it forms an airtight barrier between the space within the insulated room and said space outside it.

Preferably, the WCB further comprises a gasket, attached or attachable to said flange, the gasket being configured to form an airtight barrier between the flange and the wall or panel when the wall connection box is mounted and properly fastened.

The utility conducted through a WCB of the invention may be electric power or electric signal or fluid supply or fluid disposal. A viaduct may be configured to conduct a gas or a liquid or vacuum.

In a WCB for conducting electric power each viaduct may be configured to accommodate a pin of an electric plug introduced from said inner space or any two of the viaducts are electrically interconnectable by means of a switch operable from said inner space.

In a WCB for conducting electric signal each viaduct may include—
a core, passing through the base plate and including a plurality of electric conductors,
an outside connector, connected to said conductors and configured to accommodate a matching connector at the end of a cable extending into a space outside the insulated room and
an inside connector, connected to said conductors and configured to accommodate a matching connector at the end of a cable extending into said inner space.

In a WCB serving for fluid supply or fluid disposal each viaduct may include—
a hollow core, passing through the base plate,
an outside connector, fluidly communicative with said hollow core and configured to accommodate a connector at the end of a tube extending into a space outside the insulated room and
an inside connector, fluidly communicative with said hollow core and configured to accommodate a service connector at the end of a tube extending into said inner space.

In some configurations, the WCB may be configured to be mounted on a panel, the panel being mountable on the wall so as to cover an opening therein and to be attached to the wall in an airtight manner.

In some configurations, a viaduct may include a commercially available connector, adapted to be embedded in the base plate in an airtight manner.

In its second aspect the invention is of a panel for mounting over an opening in a wall of an insulated room having an inner space and for conducting a plurality of utilities between said inner space and any space outside the insulated room, the panel being larger than said opening and having a contact zone defined adjacent its entire periphery and comprising a plurality of cutouts,

wherein the contact zone is configured to be attachable to the wall in an airtight manner and

wherein each of the cutouts is configured as an opening over which an airtight wall connection box may be mounted in an airtight manner.

The panel may comprise a gasket, attached or attachable to said contact zone, the gasket being configured to form an airtight barrier between the contact zone and the wall when the panel is mounted and properly fastened.

### BRIEF DESCRIPTION OF THE DRAWINGS

FIG. 1A is an elevation-sectional drawing of a WCB according to the invention in a first configuration, to serve as an electric power socket.

FIG. 1B is an elevation-sectional drawing of a typical installation of the WCB of FIG. 1A.

FIG. 1C is an elevation-sectional drawing of another typical installation of the WCB of FIG. 1A.

FIG. 2A is an elevation-sectional drawing of a WCB according to the invention in a second configuration, to serve as an electric signal connector.

FIG. 2B is an elevation-sectional drawing of a typical installation of the WCB of FIG. 2A.

FIG. 2C is a trimetric drawing of the viaduct in the WCB of FIG. 2A FIG. 2D is an elevation sectional drawing of the viaduct in the WCB of FIG. 2A, including end connectors, assembled with the base plate of the WCB.

FIG. 2E is a trimetric rear-view drawing of a variation of the viaduct of FIG. 2A, assembled with the base plate of the WCB.

FIG. 3A is an elevation-sectional drawing of a WCB according to the invention in a third configuration, to serve as a gas supply connector.

FIG. 3B is an elevation-sectional drawing of a typical installation of the WCB of FIG. 3A.

FIG. 4 is an elevation-sectional drawing of a WCB according to the invention in a fourth configuration, to serve as an electric power switch.

FIG. 5A shows a typical installation of a variation of the configuration of FIG. 1A, wherein the WCB includes a plurality of electric power sockets.

FIG. 5B shows a typical installation of a variation of the configuration of FIG. 2A, wherein the WCB includes a plurality of electric signal connectors.

FIG. 6A is a face view of a panel according to the invention that includes a plurality of wall connection boxes.

FIG. 6B is an elevation-sectional drawing of a typical installation of the panel of FIG. 6A.

FIG. 6C is an elevation-sectional drawing of another typical installation of the panel of FIG. 6A.

FIG. 7A is a schematic elevation-sectional drawing of a typical installation of a first generalized configuration of a WCB according to the invention.

FIG. 7B is a schematic elevation-sectional drawing of a typical installation of a variation of the WCB of FIG. 7A.

FIG. 8A is a schematic elevation-sectional drawing of a WCB according to the invention in a fourth configuration, to serve as a gas supply connector.

FIG. 8B is an elevation-sectional drawing of a typical installation of the WCB of FIG. 8A.

### DETAILED DESCRIPTION OF PREFERRED EMBODIMENTS

Following is a description of example embodiments of wall connection boxes according to the invention, each embodiment representing an example configuration. None of the described embodiments and configurations should be construed, singly or in combination, as exhaustively representing the invention, which provides also for other embodiments and configurations that would be obvious to a practitioner of the art. Also described are typical modes of installing such wall connection boxes in a wall of an insulated room. The term “wall” is used throughout to denote also floor or ceiling or any other part enclosing the room. The term “room” is used throughout to denote also other insulated spaces. It is assumed that a wall of an insulated room is, by itself, impervious to air and has a smooth inner surface.

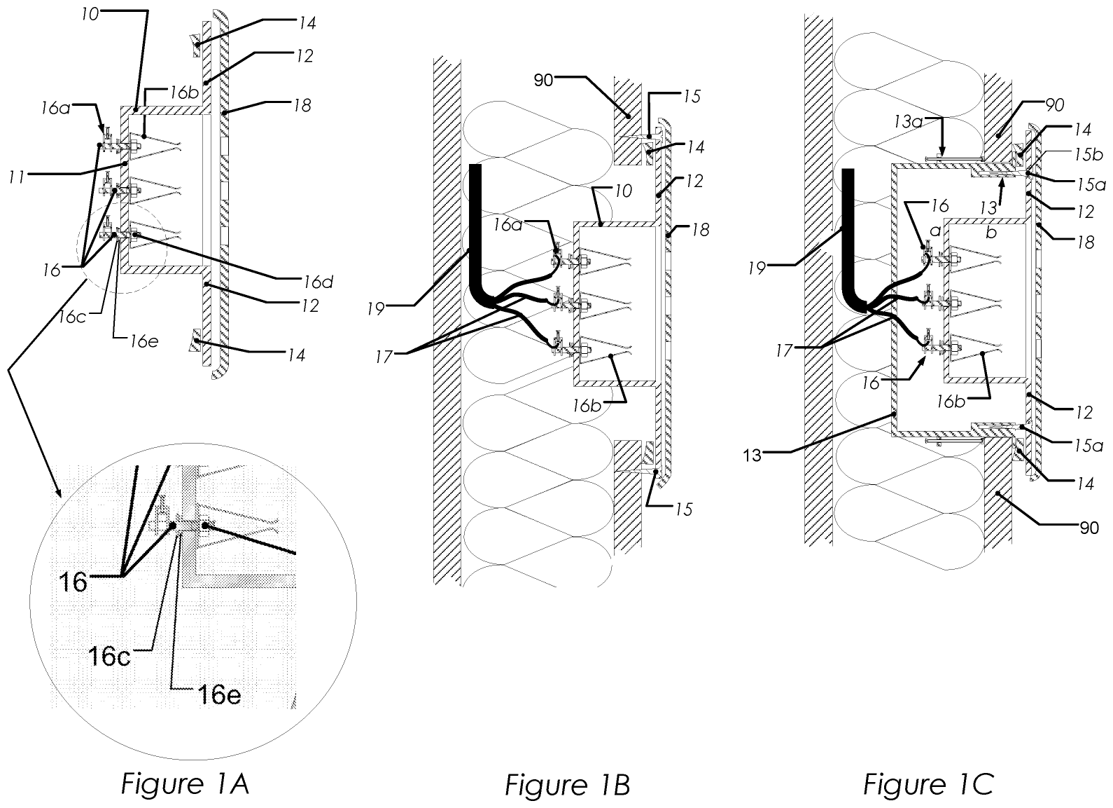

Turning first to FIG. 1A, there is shown schematically an example embodiment of a first example configuration of a wall connection box (WCB) according to the invention. This configuration is designed to serve as an electric power socket (also known as power outlet), to accommodate an electric power plug, such as would be at an end of a cable that leads to an instrument or a machine in the insulated room. The power plug may be of any configuration; however any standard configuration is preferable, so as to reduce the mass production cost of the WCB.

A rigid base plate 10 is generally shaped so as to have a flat flange 12 adjacent its entire periphery and, generally, a recessed central part 11, to form a cavity. The base plate 10 may be fabricated of any suitable material, using any suitable fabrication method, including, for example, casting or injection molding. Attached to the back face of the flange 12 is a sealing gasket 14, shaped as a complete ring. The gasket 14 may be supplied assembled with the base plate 10 or it can be supplied separately, to be applied to the flange when installing the WCB on a wall (as will be discussed below).

Within the recessed part 11 of the base plate 10 there are permanently imbedded across it a plurality of viaducts 16, here configured as electrically conducting pins. In the illustrated example there are three viaducts, arranged in a triangle (not shown in the present view), corresponding to a standard power socket—to accommodate a standard power plug; however other arrangements, corresponding to other plug configurations, are possible. Each viaduct 16 is configured so that its back end (on the left side of the plate, in the illustration) has means for attaching an electric wire thereto, such as clamp 16a and its front end (on the right side of the plate, in the illustration) has attached thereto means for electrically contacting a prong of a plug, such as spring leaf 16b. The embedding of each viaduct 16 in the base plate 10 is airtight. This condition may be achieved, for example, as part of the base plate fabrication process—for example during injection molding. Alternatively each viaduct may be fastened to the base plate by means of a flange 16c and a nut 16d, straddling the base plate 10 (as shown in the illustration), or a pair of nuts, similarly straddling the base plate 10, the viaduct pin being formed with corresponding threads; interposed at one or both faces of the base plate and surrounding the viaduct 16 are sealing gaskets 16e.

It is noted that the depth of the cavity formed by the recessed part 11 is preferably such as to avoid protrusion of the contact means beyond the inner surface of the wall (as is customary in conventional wall sockets). The embodiment according to FIG. 1A assumes that the base plate 10 is made of an electrically insulating material. To the extent that in other embodiments the base plate is electrically conductive, the viaducts 16 will each include an insulating layer at the areas of their contact with the base plate.

Also provided is a cover plate 18, configured to be semi-permanently attachable to the flange 12—for example by snap action. The cover plate 18 has holes across it, arranged in conformance with the viaducts, and shaped to accommodate the prongs of a corresponding plug.

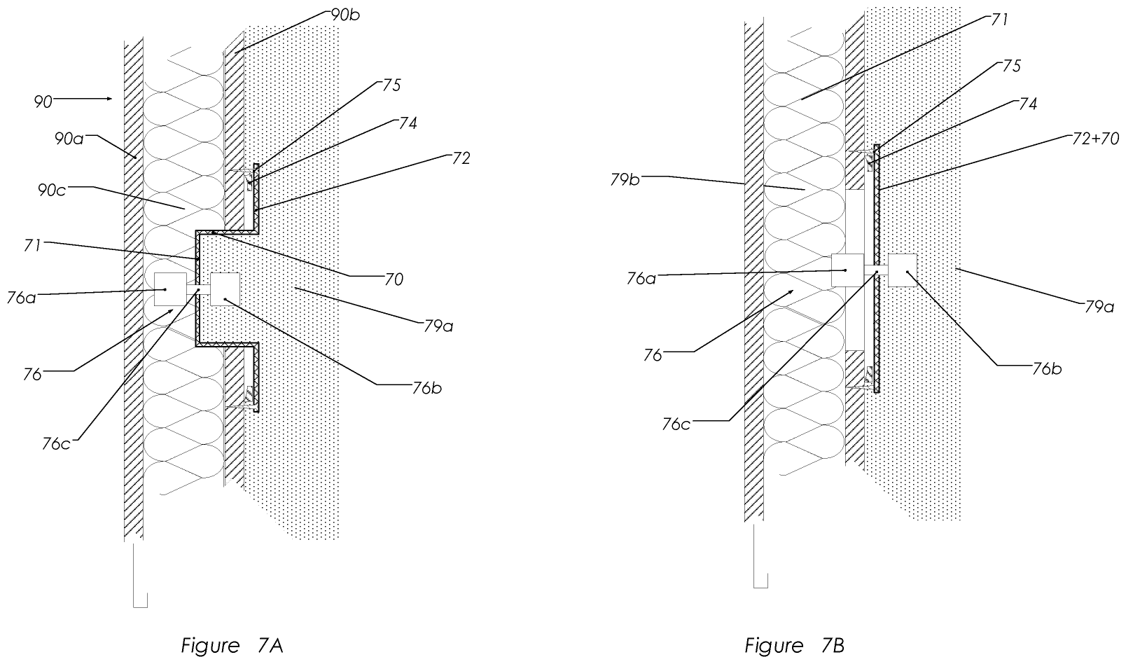

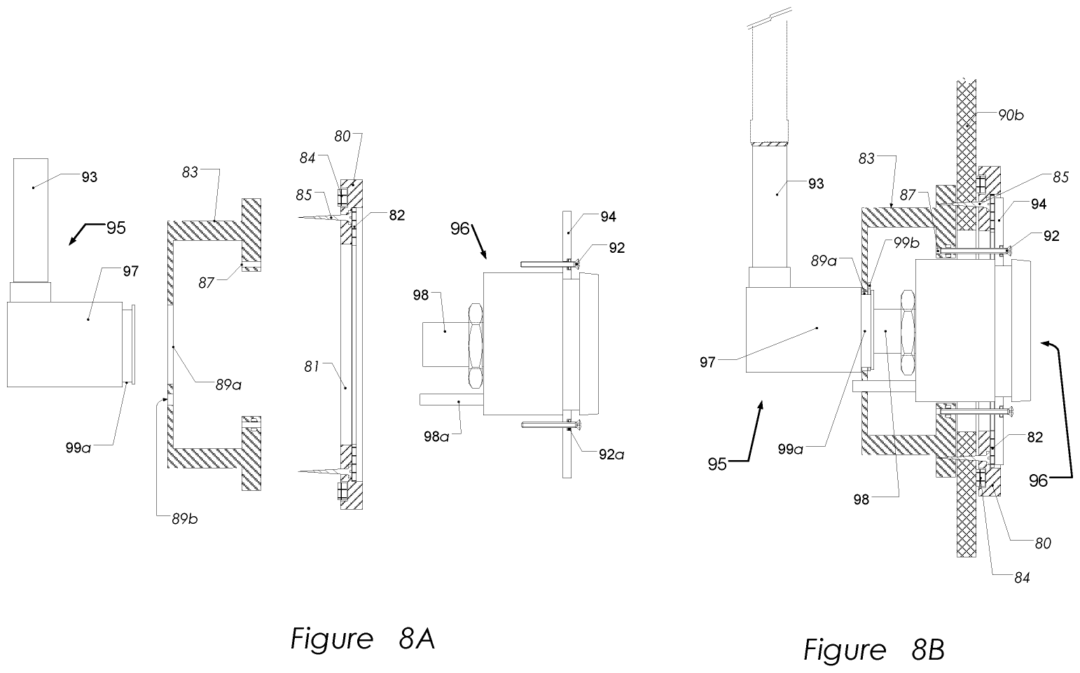

FIGS. 1B and 1C illustrate schematically, by way of examples, two typical installations of the WCB of FIG. 1A on a wall of the insulated room. A cavity (i.e. an opening through the inner face) is cut into the wall 90 to accommodate the WCB. In the installation of FIG. 1C a so-called electric box, known in the art, 13 is placed inside the cavity, so as to keep it clear and stable and so as to protect electric connection inside it. The electric box 13 may be held tight to the wall 90, for example, by screws 13a, engaging corresponding lugs of the box 13; the heads of screws 13a are eventually covered in an airtight manner by the gasket 14. The illustrations in FIGS. 1B and 1C (as well as in some of the subsequent drawings) depict the wall as being constructed of a pair of panels (such as so-called plaster- or dry boards) and a filling material between them. The general reference number 90 of a wall points here to the inner panel (i.e. the one adjacent the room space), since in the installations described below the WCB is attached to this panel. In the examples of FIGS. 7 and 8, to follow, the panels are designated by more specific reference signs. Installation of a WCB according to the invention on a wall of any other construction is equally possible, with obvious modifications of what is described herebelow or any other way.

The end of an electric supply cable 19, normally connected to the electric supply network, is introduced to the cavity or the electric box and the electric leads 17 inside it are connected to clamps 16a of corresponding viaducts. The WCB is then placed so as to protrude into the opening and so that the entire gasket 14, on flange 12, is in contact with the wall 90. The flange 12 is kept tightly pressed against the wall 90 so as to form an airtight contact between them. This pressure is achieved, for example, in the installation of FIG. 1B by means of screws 15, driven into the wall, and in the installation of FIG. 1C—by means of screws 15a, driven into corresponding sockets 13b in the electric box 13, preferably through sealing grommets 15b. It is noted that in this situation the base plate 10 and the gasket 14 together—and thus also the entire WCB—effect complete isolation between the space inside the room and any space in or behind the wall. The cover plate 18 may then be snapped on to the base plate 10—e.g. around the edges of the flange 12. It is noted that the cover plate 18 has no impact on the sealing qualities (i.e. air tightness) of the WCB.

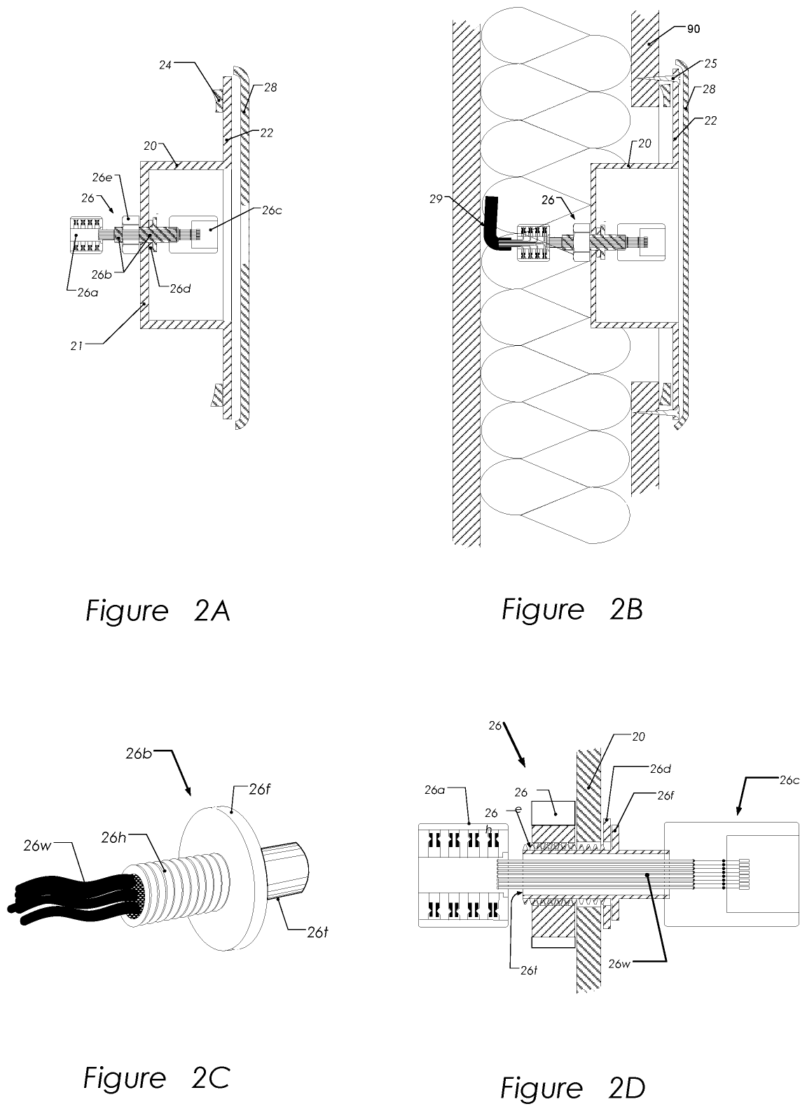

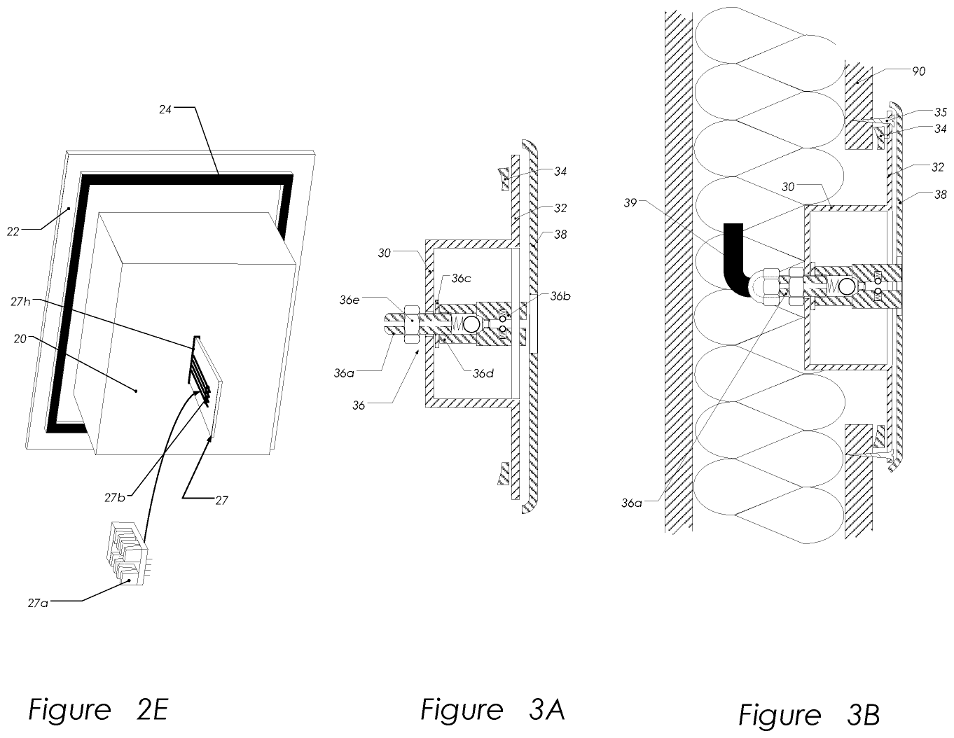

Turning next to FIG. 2A, there is shown schematically an example embodiment of a second example configuration of a wall connection box (WCB) according to the invention. This configuration is designed to serve for communication of electric signals. It is similar to the first configuration (as in FIG. 1A), in that it includes a base plate 20, formed with a flange 22 and a preferably recessed central part 21, to form a cavity. However each viaduct 26—a single one in this example—is configured as a body part 26b, with an electric signal connector 26a and 26c at each end, typically including a plurality of wires and contacts.

An example embodiment of the body part 26b of the viaduct 26, shown enlarged in trimetric view in FIG. 2C, includes a short tube 26t that passes tightly through a hole in the recessed central part 21 of the base plate 20 and is held therein in an airtight manner. The entire viaduct 26 is depicted, in length-sectional view, in FIG. 2D (assembled with the base plate 20). Through the tube 26t pass a plurality of wires 26w, protruding from both its ends and running through its entire length, embedded in a sealant, which fills the interior of the tube. Preferably, the tube 26t, the wires 26w and the sealant are cast together during fabrication to form a solid airtight entity. Additionally, the viaduct body part 26b in the embodiment of FIGS. 2C-2D preferably includes a flange 26f, solidly joined to the tube 26t, and the part of the tube to the left of the flange is formed with an external thread 26h. Preferably a grommet (or gasket) 26d is attached to the left-hand face of the flange 26f.

FIG. 2D illustrates, again in length-sectional view, by way of example, the manner in which the example embodiment of viaduct 26 according to FIG. 2C may be assembled with the base plate 20. Preferably the tube 26t is inserted from the right into, and through, a hole in the base plate (at its recessed part 21) until the grommet 26d (attached to the flange 26f) contacts the right-hand face of the base plate. A nut 26e, having a matching internal thread, is then applied to the left end of the tube 26t, engaging its thread 26h, and is turned until it contacts the left-hand face of the base plate 20. It is then turned further to tightly press the base plate between the nut 26e and the grommet 26d (which, in turn, is pressed by the flange 26f), thus forming an airtight joint between them. It is noted that the feed connector 26a is generally joined with the body part of the viaduct (still as part of the fabrication process) only after the body part has been joined with the baseplate (as described above).

Clearly, there may be other embodiments, not shown in the illustrations, of the viaduct in a signal communication configuration of the WCB according to the invention and of the manner of joining the viaduct to the base plate. For example, the body part of the viaduct may be just a tube, with wires embedded therein as described above but with a smooth outer surface, which is permanently joined to the base plate—for example by a heating process or a glue.

Attached to the outside end (left end in the illustration) of body part 26b of the viaduct 26 (e.g. tube 26t in the example embodiment) is a standard signal connector 26a, for connecting thereto an external signal cable. The wires protruding from tube 26t are connected to corresponding contacts in the connector 26a. Similarly, a standard signal connector 26c is attached to the inside end (right end in the illustration) of body part 26b and wires protruding from the latter are connected to corresponding contacts in connector 26c; this connector is adapted for connecting thereto a cable leading to an instrument in the room. Clearly, the connectors 26a and 26c may be of any type commonly known and used.

In an exemplary variation of the configuration of FIGS. 2A, 2C and 2D (not shown), designed for coaxial transmission of signals, the connectors are suitable standard coaxial connectors and the tube forming the body part of the viaduct may be a short piece of coaxial cable that is fully filled with dielectric material. Clearly also other variations of the second configuration, using any form of signal transmission and any connectors, are possible and are the subject of the present invention.

In an alternative example embodiment of a WCB configured for signal transmission, the viaduct is formed of a short piece of printed circuit board (PCB) 27 with appropriate conductor lines printed thereon. As illustrated in a rear trimetric view in FIG. 2E, the PCB body 27 of the viaduct is disposed in a matching rectangular hole 27h across the base plate 20. The PCB body 27 is held mechanically tight, as well as air-tight, within the hole 27h by any suitable means, such as, for example, epoxy. A standard signal connector 27a (such as a pushdown wire connector) is attached to the external end 27b of the body 27. Similarly a standard signal connector (not shown in the illustration) is attached to the internal end (not visible) of the body 27. As in the previously described embodiments, the base-plate 20 of the WCB of FIG. 2E is formed with a flange 22 and a gasket 24.

Other configurations of a WCB for signal transmission, not illustrated here, may include those for optical signal transmission. In such configurations the viaducts would generally include an optical fiber. Their structure will be similar to those designed for electrical signal transmission, with obvious modifications.

Optionally, a cover plate 28 (FIG. 2A) is provided, to be attached to the base plate (similarly to cover plate 18 in the configuration of FIG. 1A). The cover plate 28 has a hole, such that enables access to the connector 26c for connecting a cable thereto.

FIG. 2B illustrates schematically, by way of example, a typical installation of the WCB of FIG. 2A on a wall of the insulated room. It is similar to that of the first configuration (as illustrated in FIG. 1B), except that a signal cable 29 is connected to the back connector of the viaduct. An alternative installation, involving an electric box (similarly to the electric box 13 illustrated in FIG. 1C) is also possible, as would be readily understood by a practitioner of the art.

Turning now to FIG. 3A, there is shown schematically an example embodiment of a third example configuration of a wall connection box (WCB) according to the invention. This configuration is designed to serve for supplying gas for use within the insulated room. It is similar to the second configuration (as in FIG. 2A), in that it includes a base plate 30 formed with a flange 32, to which a gasket 34 is attached. Here, however, the viaduct 36 comprises a hollow tube. The tube 36, again, passes tightly through a hole in the base plate 30 and is held therein in an airtight manner—for example by a grommet 36c, pressed against the base plate by a housing 36d, surrounding the tube 36 and fixedly attached thereto, and by a tightening nut 36e.

The outer end 36a (on the left) of the viaduct tube 36 is configured to a have a gas supply tube attached thereto in any manner known in the art, such as, for example, a standard inlet fitting. To the inner end (on the right) of the viaduct tube 36 is attached a gas outlet fitting 36b— preferably a quick plug gas connector—configured to have a flexible gas tube reversibly connected thereto, for supplying gas to any instrument in the room. Optionally, a manually operated valve may be interposed between the inner end of the viaduct tube 36 and the gas outlet fitting 36b.

As illustrated in FIG. 3B, installation of the WCB in this configuration is similar to that of the second configuration. A supply gas tubing 39, with an appropriate end fitting, is connected to the inlet fitting 36a. The flange 32 is held tightly to the wall 90, with the gasket 34 between them, by means of, for example, screws 35. An optional cover plate 38 may by mounted on the flange—for example by a snap action.

Clearly, variations and modifications of a WCB in the third configuration are possible, such that provide supply of other fluids—gaseous or liquid (including water), as well as exhaust or disposal of fluids; exhaust of gases may include also suction- and/or vacuum services. The structure of their viaducts and their end fittings, to match the intended purpose, should be obvious to practitioners of the art; however, as long as the viaducts pass through the base plate in an airtight manner, such as described hereabove, a WCB with these variations and modifications remains the subject of the present invention.

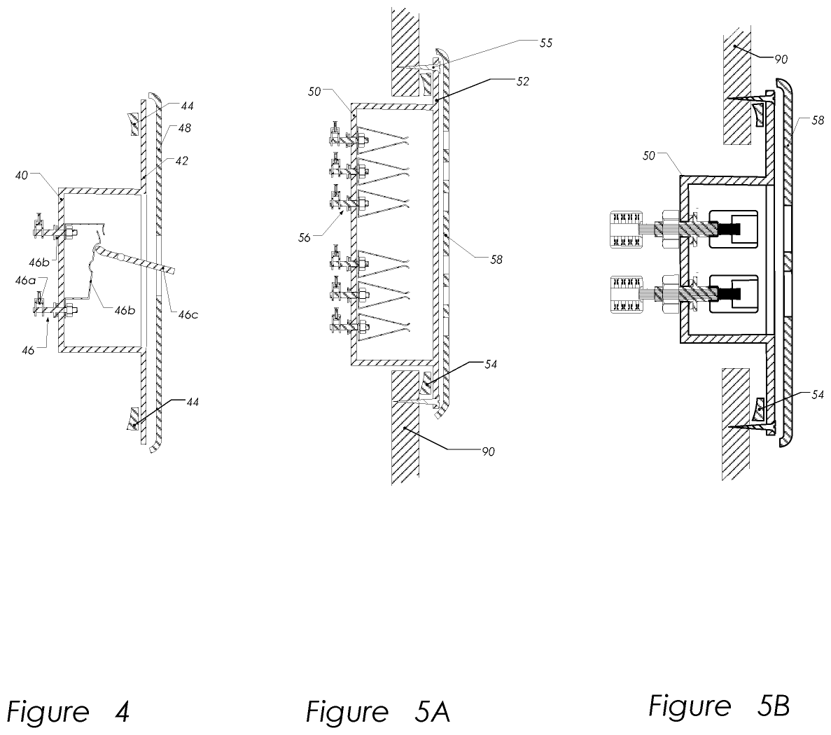

FIG. 4 illustrates schematically an example embodiment of a fourth example configuration of a wall connection box (WCB) according to the invention. This configuration is designed to switch an electric current—for example, to a lighting fixture in a wall or ceiling of the insulated room or to an external device. The illustrated example is of a SPST switch. It is similar to the first configuration (e.g. FIG. 1A), in that it comprises a plurality (two, in this case) of electric current-conducting viaducts 46, disposed across a base plate 40 in an airtight manner, each provided with a clamp 46a. Here, however, the spring leaf 46b of each viaduct 46 is formed so as to enable interruptible electric contact between the two viaducts. The contacting action may be effected by means of a lever 46c. Alternatively, a standard commercially available switch (not shown) may be mounted on the inside surface of the base plate 40 and electrically connected to the viaducts 46. The cover plate 48 is provided with a hole, such that accommodates the lever 46c. Installation of the WCB of FIG. 4 is similar to that of FIG. 1B or FIG. 1C, wherein external wires are connected to clamps 46a and the flange 42 is tightened to the wall, with the gasket 44 intervening (thus forming an airtight seal).

FIG. 5A shows an example embodiment of another example configuration that is a modification of the first configuration described above, namely a WCB with a plurality of electric power sockets. In the illustrated example there are two sockets, each consisting of a group of three viaducts 56—similar to those in the embodiment of FIG. 1A. All the viaducts of all the groups (sockets) are embedded in the same single base plate 50. A common cover plate 58 is provided with holes located correspondingly to the viaducts. Clearly also a greater number of power sockets, each with its respective viaducts, may be embedded in a single base plate. FIG. 5A also illustrates a manner of mounting the WCB on a wall—similarly to that of FIG. 1B; here, flange 52 is pressed against the wall 90, with the intervening gasket 54, by means of, for example, screws 55. Other manners are also possible, including one similar to that of FIG. 1C, involving a suitable electric box.

FIG. 5B shows an example embodiment of another configuration that is a modification of the second configuration described above, namely a WCB with a plurality of signal transmitting viaducts. In the illustrated example there are two signal viaducts 26, similar to those of FIG. 2A, embedded in a single base plate 50. They are each connectable at its back end to an external cable. The cover plate 58 has two correspondingly positioned holes. Clearly also a greater number of signal viaducts may be embedded in a single base plate. In a similar manner a single WCB can also include a plurality of fluid-conducting viaducts (such as discussed, for example, above in relation to FIG. 3A), embedded in a single base plate.

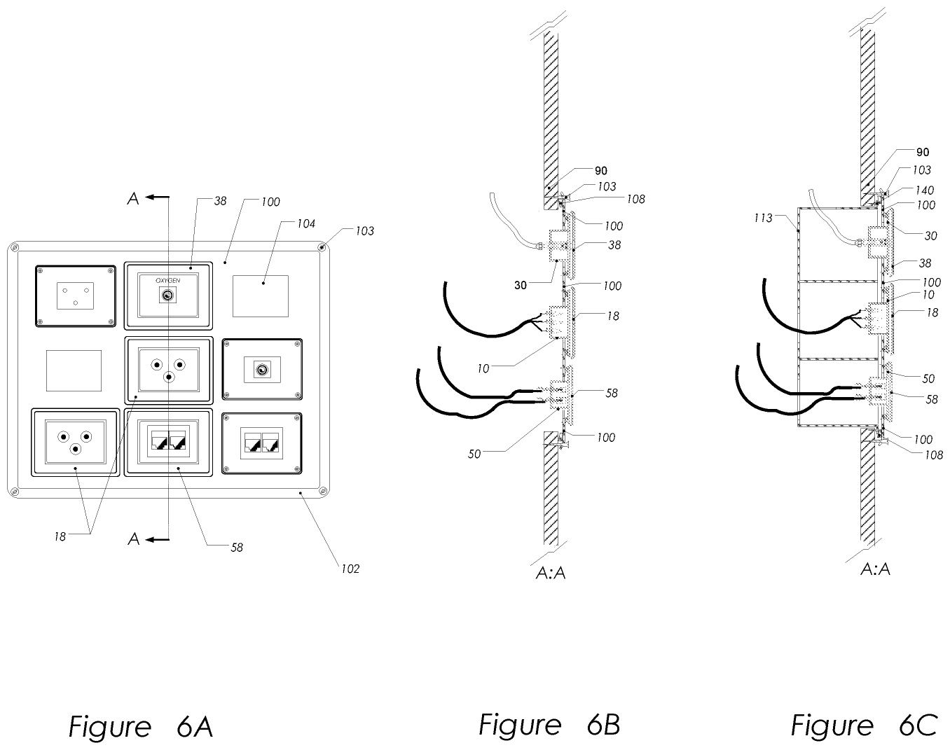

Turning now to FIGS. 6A and 6B, there is illustrated—in a front view and elevation-sectional view, respectively—an example embodiment of another aspect of the invention, namely a panel, comprising a plurality of WCBs according to the invention, which may be placed as a whole over a suitable opening in a wall, while maintaining isolation between the space within the insulated room and any spaces in, and behind, the wall. The panel 100 is preferably flat, has a rim 102 defined adjacent its entire periphery and a plurality of cutouts 104, preferably arranged as an array (of 3×3 in the illustrated example), each cutout shaped and sized to accommodate the base plate of a WCB. Various WCBs, such as described hereabove, may be mounted over the cutouts, possibly protruding back of the panel. The mounting of each WCB on the panel is similar to its mounting on a wall as described above, namely its flange with the attached gasket is pressed against the panel in the area surrounding the cutout, using suitable fasteners, so as to make their joint airtight. Unused cutouts are covered by solid blank base plates with gaskets (not shown), tightly attached to the panel, similarly to the WCBs. A ring-shaped gasket 108 is attached to the entire rim 102.

The elevation view of FIG. 6B corresponds to the section line A-A in FIG. 6A, running along the middle column of WCBs, which in the illustrated example include (listed bottom to top) a double-viaduct signal communication WCB (similar to that of FIG. 5B and having a base plate 50 and cover plate 58), a power socket WCB (similar to that of FIG. 1A and having a base plate 10 and cover plate 18) and a gas supply WCB (similar to that of FIG. 3A and having a base plate 30 and cover plate 38). Clearly, WCBs of also other configurations, including any with multiple viaducts or power sockets, are possible. Any arrangement of WCBs of various configurations, including a plurality of WCBs of any one configuration, is generally allowed—subject to considerations of external connections and of convenient usage.

As shown in FIG. 6B, the entire panel 100 may be mounted on a wall 90, over a suitably cut opening. The rim 102, with the gasket 108, may be pressed against the wall around the opening, using suitable fasteners, such as screws 103, so as to effect an airtight joint. The mounting of individual WCBs 110 on the panel 100 may be carried out before or after mounting the panel on the wall. FIG. 6C shows, in a similar elevation-sectional view, a variation of the manner of mounting the panel. Here there is also provided a suitable electric box 113, mountable within the opening in the wall 90, using for example screws 140; the electric box is preferably divided into compartments, corresponding to the individual WCB locations. The panel 100 is, again, tightly attached to the wall at its rim 102, through gasket 108, using for example screws 103, to maintain air tightness.

It will be appreciated that the assembly of the panel 100 and the WCBs mounted thereon (including blank base plates), when fully mounted as described above, forms an airtight barrier between the space within the insulated room and any outside space, while allowing the conduction of electric currents and fluids between the two spaces.

By way of summary, a first general configuration of a WCB according to the invention in its first aspect (which includes the specific configurations described heretofore with reference to FIGS. 1-5) will now be described in generic terms, with reference to FIGS. 7A and 7B. There is generally provided a wall connection box (WCB), configured to be mounted over a suitable opening in the inner face, or an inner panel, of a wall 90 of an insulated room, for conducting a utility (such as electric currents or fluids) between the space inside the room and any space outside it, the WCB including a base plate 70 and one or more viaducts 76, embedded in, and across, the base plate in an airtight manner. Each viaduct is configured to conduct a particular type of utility—whether, for example, an electric current, electric or optical signal, a liquid or a gas.

The base plate 70 has a flange (or flange area) 72 defined proximate its entire periphery and, attached, or attachable, to the flange 72, is a sealing gasket 74. The flange 72 and the gasket 74 are configured so that when the base plate is mounted on the wall 90, covering the opening and held pressed against it (by suitable fasteners, such as screws 75), there is an airtight joint between them.

Each viaduct 76 conceptually comprises a core 76c, which is its part that is embedded in, and across, the base plate in an airtight manner and through which the utility is conducted. At the outer end of the core 76c (i.e. at the end that will be outside the space of the room when the WCB is mounted) there is attached an outside connector 76a, configured to conduct the particular utility between an outside conductor connected to it and the core. At the inner end of the core 76c (i.e. at the end that will be inside the space of the room when the WCB is mounted) there is attached an inside (or in-room) connector 76b, configured to conduct the particular utility between the viaduct and an inside conductor connected to it.

It is noted that any embodiment of any configuration of a WCB according to the invention is preferably designed so that it may be fabricated and marketed complete and ready for installation, with the base plate and all the viaducts fully assembled together. As shown in the in the illustrations of FIGS. 7A and 7B, installation of such a WCB requires only mounting the base plate on the wall 90, with the gasket 74 pressed between the flange 72 and the inside surface of the wall by means of, for example, screws 75. Of course the outside connector 76a must also be connected to a feed line at some point of the installation process. Finally a face plate may be attached to the base plate.

The base plate 70 may be formed in a variety of shapes, to suit a variety of applications, viaduct types and wall structures. Two example shapes are illustrated differentially in FIGS. 7A and 7B. In FIG. 7B the base plate 70 is essentially flat. In FIG. 7A (as well as in all the previously described and illustrated examples) the base plate 70 is formed with a recess 71, centrally to the flange; the inside connector 76b may then remain entirely behind the plane of the inner surface of the wall. Generally the recess may have any desired depth; a very small depth may result in a shallow-recess form—nearing the flat form of FIG. 7B.

It is noted that a WCB in its first general configuration (as illustrated for example in FIGS. 7A and 7B) is mountable on any type of a wall, having any structure and made of any material, as long as it has an essentially smooth inner surface and as long as a cavity or hole may be formed therein to accommodate the outer parts of the WCB, including the outer end of the viaducts. The wall 90 illustrated in FIGS. 7A and 7B, by way of example only, is constructed of an inner board (or panel) 90b, an outer board (or panel) 90a and filling material 90c; such a wall is frequently, but not exclusively, used for insulated rooms.

Turning now to FIGS. 8A and 8B, there is illustrated, in vertical sectional view, an example embodiment of a wall connection box (WCB) according to the invention, designed to serve for supplying gas for use within the insulated room. This is an alternative configuration to that illustrated in FIGS. 3A and 3B (described above) and may serve as an example of a second general configuration of a WCB according to the invention in its first aspect. Unlike the first configuration, discussed above, the second general configuration is characterized by the viaduct being essentially a commercially available connector for the desired service. The manner of incorporating such a connector in the WCB will become apparent from the description to follow and will be further discussed in the sequel.

The embodiment of FIGS. 8A and 8B incorporates a commercially available gas connector having a pair of members that are interconnectable, for example, through a respective male- and female adaptor. An example of such a connector, illustrated and discussed herein, is model ENV 737-6, made by Silbermann Medical Gas systems. FIG. 8A shows the various components of the WCB separated, i.e. before factory assembly, while FIG. 8B shows the WCB assembled and mounted, for example, on an inner panel 90b of a wall. The WCB generally comprises four main components, arranged in two sub-assemblies: An inside sub-assembly (on the right in the illustrations) includes a base plate 80 and the inside member 96 of the gas connector, having for example a male adaptor 98. An outside sub-assembly (on the left in the illustrations) includes a support structure 83 (“support”, for short), preferably made of a polymer, and the outside member 95 of the gas connector, having for example a female adaptor 97.

The outside part 95 of the gas connector is generally adapted to have a feed pipe connected thereto from the outside—for example, by means of the extension tube 93. The inside part 96 of the gas connector is generally adapted to have a supply tube (for connecting to an instrument inside the insulated room) connectable thereto—for example, by means of a so-called “quick connect” that may be removably joined to the connector in a snap action.

The adaptor 97 of the outside member 95 of the gas connector has a short protrusion 99a, formed so that the adaptor 97 may be joined to the support 83 by inserting the protrusion 99a through a commensurate hole 89a in the back plate of the support 83 and so that this joint may then be secured by a C-type ring clamp 99b (as seen in FIG. 8B). It is noted that with other types of connectors the means and manner of such joining may be different.

The inside member 96 of the example gas connector is formed with a flange 94, to generally serve for mounting the connector on a wall. The flange 94 is pierced by holes, through which screws 92 are inserted. The support 83 has corresponding holes 87 that are threaded so as to engage screw 92. As can be seen in FIG. 8B, the screws 92 and holes 87 are adapted, and may serve, to cooperatively hold the inner member 96 of the connector to the support 83 and keep them mutually pressed when mounted on respective faces of inner wall panel 90b. The aforementioned holes in the flange are preferably provided with grommets 92a, to keep them airtight when assembled with the screws 92. The inside member 96 of the example gas connector preferably has a key stud 98a, having a cross-sectional shape that identifies the gas type to be conducted. The back plate of the support 83 has a hole 89b, shaped to match and accommodate the key stud 98a.

The base plate 80 is provided with a gasket 84—similarly to the base plate of the previously discussed embodiments of the WCB. In the presently discussed embodiment, however, the base plate is also provided with a second gasket 82, placed on a surface that faces the room. It is adapted to have the flange 94 of the connector pressed against it so as to form an airtight joint. Preferably the surface to which the second gasket 82 is attached is recessed so as to accommodate the flange 94. The base plate 80 has an opening 81 across it, large enough to accommodate the main body of the inside member 96 of the connector, including the screws 92, but considerably smaller than the diameter of the flange 94.

A fully assembled WCB, with the components described hereabove, is shown in FIG. 8B mounted on an inner wall panel 90b. The outside member 95 of the gas connector is joined to the support 83 by means of the protrusion 99a being engaged by the hole 89a and secured by the C clamp 99b. The inside member 96 of the gas connector is held in place, with its male adaptor 98 being engaged by the female adaptor 97 of the outside member 95, as follows: By means of screws 92 being tightly engaged by holes 87 in the support 83, the support 83 is pressed against the outside surface of the wall panel 90b, while the flange 94 is pressed against the gasket 82 and thereby against the base plate 80, which in turn is pressed against the gasket 84 and thereby against the inner surface of the wall panel 90b. Screws 85 may be driven into the wall, to further tighten the sealing effect of the gasket 84 and to secure the position of the base plate and thereby—of the entire assembly. It is noted that when screws 85 are thus engaged, each member 95 and 96 of the gas connector may be removed or re-assembled while keeping the base plate 80 and the support 83 fixed to the wall. A gas feed pipe (from an external supply system) with a connection means (shown schematically by dashed lines) may then be connected to the extension tube 93.

It will be appreciated that the example WCB, as thus assembled and mounted, forms an airtight barrier between the inside space of the room and the outside world, while allowing supply of gas to any instrument connected by a tube to the inside member of the connector. It is noted that the configuration represented by the above embodiment is conceptually similar to those previously described hereabove, in that the commercially available connector, as utilized herein, takes on the role, or is a particular configuration, of a viaduct held across a base plate in an airtight manner, the base plate, in turn, being pressed against the wall in an airtight manner.

The components of the WCB described hereabove and depicted separately in FIG. 8A may be variously assembled into sub-assemblies before being fully assembled and mounted as depicted in FIG. 8B. Such sub-assemblies would, for example, comprise the parts of a WCB as marketed and shipped, which would subsequently be fully assembled by an installer so as to be mounted on a wall. Thus, a first sub-assembly may be the combination of the outside member 95 of the connector and the support structure 83 (which would be joined as described above). A second sub-assembly may be the inside member 96 of the connector (possibly a modified version of the part supplied from its manufacturer) and a third sub-assembly may be the base plate 80, with the attached gasket.

The installation process may, for example, proceed as follows: First, the extension tube 93 of the outside member 95 of the connector is connected to a supply pipe and then the outside member 95 is connected to the support 83 (if not pre-assembled with it). Next the base plate 80 is attached to the outside face of wall panel 90b (with the intervening gasket 84) by means of screws 85. Then the support 83 (with the attached outside member 95) is placed against the inside face of wall panel 90b, properly aligned with the base plate, whereafter the screws 85 are further driven into the support 83 and finally tightened—to keep both the base plate and the support tightly secured to the wall panel. Next the inside member 96 of the connector is inserted through the hole 81 of the base plate 80 and its male adaptor 98 is made to be engaged by female adaptor of the outside member 95, while its flange 94 is placed over the second gasket 82 on the base plate 80 (preferably within the recessed portion of its inside face), whereby the inside member 96 becomes properly positioned with respect to all the other parts. Finally the screws 92 are made to be engaged by the tapped holes 87 in the support 83 and are tightened, so as to keep the entire assembly tightly straddling the wall panel 90b (as depicted in FIG. 8B).

The configuration of a gas supply WCB described above was in terms of a particular examplary commercially available connector. Clearly other commercially available gas connectors may be utilized in a WCB according to the invention, wherein the structure of the WCB may vary so as to accommodate any such connector, the variation being readily designed by persons knowledgeable in the art. For example, if the inside member of the connector does not have a flange, the base plate may be designed to otherwise join with it in an airtight manner. On the other hand, and as another example, if the flange of the connector planar and large enough, it may take the role of the flange of the base plate in previously described configurations and thus may be provided with a gasket for mounting it directly on the wall; in this case it will also accommodate fastening screws, similar to screw 85 and 92 and a separate base plate (such as 80) would be obviated.

As another example, the commercially available gas connector may comprise a single member, the outside end of which may be directly connectable to a supply pipe. In this case, there will be no outside support structure (such as 83) and the connector will be joined only to a base plate, installable from inside similarly to previously described configurations. If this connector includes a flange, the latter may be configured to be tightened against the wall—with or without an intervening base plate—similarly to what was described above with respect to FIG. 8B.

As mentioned above, the configuration represented by the embodiment of FIGS. 8A and 8B is an example of a second general configuration of a WCB according to the first aspect of the invention. This general configuration is characterized by a viaduct that includes, or entirely consists of, a commercially available connector, which, according to the intended service, may conduct a fluid (gas or liquid) or an electrical current or a signal (electrical or optical). In each case there is provided a base plate that is formed and adapted to be joined to the connector in an airtight manner. As in the first general configuration (represented, for example, by the embodiments of FIGS. 7A and 7B), the base plate has a gasket attached along its periphery, configured so that it can be pressed against the inner surface of the wall in an airtight manner. Also similarly to the first general configuration, a feed line and a supply line can be attached to the outside end and inside end, respectively, of the connector-based viaduct, which lines may be electric or optical cables or fluid-conducting tubes, as befitting the intended service. It will be appreciated that a WCB according to the invention, when mounted on a wall as described, even without applying any sealants, glues or filling materials, forms an airtight barrier between the space within the insulated room and any outside space, while allowing the conduction of the particular utility between the two spaces It will be further appreciated that the structure of such a WCB, for whatever utility it serves, is relatively simple, rendering the WCB robust and economically manufacturable.

According to the second aspect of the invention, any type of WCB in the first aspect of the invention, such as represented in FIG. 7 or FIGS. 8, may be mounted on a flat panel, at a suitable cutout within it, in an airtight manner, as shown, for example, in FIGS. 6A-6C. The panel, with a plurality of such WCBs mounted on it (and blank base plates similarly covering unused cutouts), may be mounted on the wall in an airtight manner, as shown for example in FIGS. 6B-6C. It will be appreciated that also such a panel, when mounted on a wall as described, even without applying any sealants, glues or filling materials, forms an airtight barrier between the space within the insulated room and any outside space, while allowing the conduction of various utilities between the two spaces.

1. An airtight wall connection box, for mounting over an opening in a wall of an insulated room having an inner space or over an opening in a panel mounted in said wall, and for conducting a utility between said inner space and any space outside the insulated room, the wall connection box comprising—
a solid base plate, larger than said opening, having two faces and formed with a flat flange along its entire periphery;
one or more viaducts, each embedded in the base plate in an airtight manner so as to protrude from each of the faces and configured to conduct all or part of said utility;
wherein the wall connection box is configured so that, when mounted on said wall or said panel over said opening and properly fastened, it forms an airtight barrier between the space within the insulated room and said space outside it.

2. The wall connection box according to claim 1, further comprising a gasket, attached or attachable to said flange, the gasket being configured to form an airtight barrier between the flange and the wall or panel when the wall connection box is mounted and properly fastened.

3. The wall connection box according to claim 1, wherein the utility is electric power.

4. The wall connection box according to claim 3, wherein each viaduct is configured to accommodate a pin of an electric plug introduced from said inner space.

5. The wall connection box according to claim 4, wherein there are two or more groups of said viaducts, each group configured to accommodate the pins of a corresponding electric plug.

6. The wall connection box according to claim 3, wherein there are at least two viaducts, two of the viaducts being electrically interconnectable by means of a switch operable from said inner space.

7. The wall connection box according to claim 1, wherein the utility is electric signal.

8. The wall connection box according to claim 7, wherein each viaduct is configured to transmit an electric signal and includes—
a core, passing through the base plate and including a plurality of electric conductors,
an outside connector, connected to said conductors and configured to accommodate a matching connector at the end of a cable extending into a space outside the insulated room and
an inside connector, connected to said conductors and configured to accommodate a matching connector at the end of a cable extending into said inner space.

9. The wall connection box according to claim 1, wherein the utility is optical signal and each viaduct includes a core, passing through the base plate and including an optical fiber.

10. The wall connection box according to claim 1, wherein the utility is fluid supply or fluid disposal.

11. The wall connection box according to claim 10, wherein each viaduct includes—
a hollow core, passing through the base plate,
an outside connector, fluidly communicative with said hollow core and configured to accommodate a connector at the end of a tube extending into a space outside the insulated room and
an inside connector, fluidly communicative with said hollow core and configured to accommodate a service connector at the end of a tube extending into said inner space.

12. The wall connection box according to claim 10, wherein each viaduct is configured to conduct a gas or a liquid or vacuum.

13. The wall connection box according to claim 1, configured to be mounted on a panel, the panel being mountable on the wall so as to cover an opening therein and to be attached to the wall in an airtight manner.

14. The wall connection box according to claim 1, wherein a viaduct includes a commercially available connector, adapted to be embedded in the base plate in an airtight manner.

15. The wall connection box according to claim 14, wherein the commercially available connector is configured to transmit gas and includes a pair of mutually connectable members,
the wall connection box further comprising a support, attachable to the wall,
wherein a first member of said pair of members is adapted to be embedded in the base plate in an airtight manner and the second member of said pair of members is adapted to be attached to said support.

16. A panel for mounting over an opening in a wall of an insulated room having an inner space and for conducting a plurality of utilities between said inner space and any space outside the insulated room, the panel being larger than said opening and having a contact zone defined adjacent its entire periphery and comprising a plurality of cutouts,
wherein the contact zone is configured to be attachable to the wall in an airtight manner and
wherein each of the cutouts is configured as an opening over which an airtight wall connection box may be mounted in an airtight manner.

17. The panel according to claim 16, further comprising a gasket, attached or attachable to said contact zone, the gasket being configured to form an airtight barrier between the contact zone and the wall when the panel is mounted and properly fastened.
